(19) United States
(12) Patent Application Publication
(10) Pub. No.: US 2012/0119940 A1
(43) Pub. Date: May 17, 2012

(54) RADAR APPARATUS WITH MULTI-RECEIVER CHANNEL

(75) Inventors: Akiyoshi Mizutani, Nagoya (JP); Yutaka Ninoyu, Obu-shi (JP)

(73) Assignee: DENSO CORPORATION, Kariya-city (JP)

(21) Appl. No.: 13/294,354

(22) Filed: Nov. 11, 2011

(30) Foreign Application Priority Data
Nov. 12, 2010 (JP) 2010-253929

(51) Int. Cl. G01S 13/34

(52) U.S. Cl. 342/133

(57) ABSTRACT

In a radar apparatus, a signal processor successively selects outputs of a plurality of receiving channels at time intervals and repeat, at a sampling cycle, a sequence of the successive selections of the outputs of the plurality of receiving channels, thus sampling values of a beat signal. The signal processor changes a value of the time interval for a current sequence of the successive selections of the outputs of the plurality of receiving channels so that the value of the time interval for the current sequence of the successive selections of the outputs of the plurality of receiving channels is different from a value of the time interval for a previous sequence of the successive selections of the outputs of the plurality of receiving channels.

### CROSS REFERENCE TO RELATED APPLICATIONS

This application is based on Japanese Patent Application 2010-253929 filed on Nov. 12, 2010. This application claims the benefit of priority from the Japanese Patent Application, so that the descriptions of which are all incorporated herein by reference.

### TECHNICAL FIELD

The present disclosure relate generally to a radar apparatus designed to emit a radar wave modulated in frequency in time series and receive a return of the radar wave from a target through a plurality of channels to determine at least the azimuth or angular direction of the target.

### BACKGROUND

Recently, a radar is tried to be used in an anti-collision device of motor vehicles. FM-CW (Frequency-Modulated Continuous Wave) radars designed to measure both the distance to and relative speed of a target are proposed for ease of miniaturization and reduction in manufacturing cost thereof.

Typical FM-CW radars transmit, as a transmitted wave, a signal Ss, which is frequency modulated by a triangular wave to have a frequency that increases and decreases cyclically in a linear fashion, and receive a radar return of the transmitted wave from a target as a received signal Sr.

The received signal Sr is delayed with respect to the transmitted signal Ss by time Td; the time Td is required for the transmitted wave to travel from the radar to the target and for the return of the transmitted wave to travel from the target to the radar. That is, the delay time Td depends on the distance between the radar and the target. This results in that the received signal Sr is doppler-shifted in frequency by a frequency Fd with respect to the transmitted signal Ss; the frequency Fd depends on the relative speed between the target and the radar.

Mixing the received signal Sr and the transmitted signal Ss together by a mixer generates a beat signal B having a frequency identical to a difference in frequency between the received signal Sr and the transmitted signal Ss. The beat signal B is comprised of an upbeat signal Bu during the frequency of the transmitted signal Ss increasing, and a downbeat signal Bd during the frequency of the transmitted signal decreasing. When the frequency of the upbeat signal Bu, which will be referred to as a beat frequency in a modulated frequency-rising range, is expressed as fu, and the frequency of the downbeat signal Bd, which will be referred to as a beat frequency in a modulated frequency-falling range, is expressed as fd, the distance R and the relative speed V between the radar and the target are expressed by the following equations [1] and [2]:

$$\begin{matrix}R = \frac{c \cdot T}{8 \cdot Δ F} \cdot ( fu + fd ) & [ 1 ] \\ V = \frac{c}{4 \cdot Fo} \cdot ( fu - fd ) & [ 2 ]\end{matrix}$$

where c represents the propagation speed of a radio wave, T represents a period (cycle) of the triangular wave, ΔF represents a variation in frequency of the transmitted signal Ss, and FO represents a center frequency of the transmitted signal Ss.

In use of such an FM-CW radar in motor vehicles, it is important to, measure the azimuth or angular direction of a target as well as the distance R and the relative speed V between the radar and the target.

U.S. Pat. No. 6,292,129 corresponding to Japanese Patent Publication No. 3622565 discloses a radar apparatus capable of measuring the azimuth of a target.

The radar apparatus disclosed in the US patent is provided with a transmitter, a plurality of receiving antennas, a receiving switch, a control circuit, a receiving circuit, and a signal processor. The transmitter produces a signal so modulated in frequency as to change with time cyclically and transmits the signal as a radar wave.

Each of the plurality of receiving channels receives a return of the radar wave from a target as a received signal. The control circuit is designed to control the receiving switch to successively select any one of electrical paths between the receiving circuit and the respective receiving channels, thus successively supplying the received signals from the respective receiving channels to the receiving circuit; a cycle of the successive selections is shorter than a cycle of the change in the frequency of the transmitted signal.

The receiving circuit mixes the received signals from the respective receiving antennas with a local signal having the same frequency as that of the transmitted signal, thus generating upbeat signals Bu and downbeat signals Bd of the respective channels. Because the control circuit repeats the cycle of the successive selections, the receiving circuit samples values of a pair of the upbeat and downbeat signals Bu and Bd from each receiving channel.

The signal processor performs, using the sampled values of the pair of the upbeat and downbeat signals Bu and Bd from each receiving channel, a pair-matching method described hereinafter.

### SUMMARY

Specifically, the signal processor performs digital signal processing, such as FFT (Fast Fourier Transform), to sample one or more pairs of peaks in strength of frequency components in the upbeat signals Bu and peaks in strength of frequency components in the downbeat signals Bd. Then, the signal processor extracts a pair of a peak (upbeat-signal peak) in strength of a frequency component in the upbeat signals Bu and a peak (downbeat-signal peak) in strength of a frequency component in the downbeat signals Bd; the upbeat-signal and downbeat-signal peaks of the extracted pair are matched with each other. Thus, the signal processor obtains, in addition to the distance and the relative speed between the radar apparatus and the target, information associated with the azimuth of the target based on the arrangement of the selected receiving antennas at the moment when it is determined that the upbeat-signal and downbeat-signal peaks of the extracted pair are matched with each other.

Such an FM-CW radar apparatus using the pair-matching method for obtaining positional information of a target samples values of a pair of the upbeat and downbeat signals Bu and Bd, and performs digital signal processing, such as FFT, based on the sampled values of the pair of the upbeat and downbeat signals Bu and Bd. Thus, if a target is located at a distance, which corresponds to a frequency higher than the Nyquist frequency (the half of the frequency of the sampling), from the radar apparatus, the frequency components of a beat signal corresponding to the target, which are higher than the Nyquist frequency, are shifted to frequency components lower than the Nyquist frequency; these frequency shifted components are called “aliases”, and the frequencies that shift are called “folded” frequencies.

Thus, the FM-CW radar apparatus may incorrectly detect the positional information of the target based on the falsely frequency components (aliases) of the beat signal.

In view of the circumstances set forth above, one aspect of the present disclosure seeks to provide radar apparatuses, which are designed to address at least one of the problems set forth above.

Specifically, an alternative aspect of the present disclosure aims to provide such radar apparatuses capable of correctly detecting a target even if the target is located at a distance, which corresponds to a frequency higher than Nyquist frequency as the half of the frequency of sampling of beat signals, from the radar apparatus.

According to one aspect of the present disclosure, there is provided a radar apparatus. The radar apparatus includes a transmitter configured to generate a transmit signal so modulated in frequency to cyclically change with time, and transmit the transmit signal as a radar wave. The radar apparatus includes a receiver comprising a plurality of receiving channels. Each of the plurality of receiving channels is configured to receive a return of the radar wave from a target as a received signal. The receiver is configured to output a beat signal based on the received signals of the plurality of receiving channels and a local signal having a frequency identical to the frequency of the transmit signal. The beat signal is composed of outputs of the plurality of receiving channels. The radar apparatus includes a signal processor configured to successively select the outputs of the plurality of receiving channels at time intervals and repeat, at a sampling cycle, a sequence of the successive selections of the outputs of the plurality of receiving channels, thus sampling values of the beat signal; extract at least one pair of a first frequency component of one of the sampled values of the beat signal in a modulated frequency-rising range of the beat signal and a second frequency component of one of the sampled values of the beat signal in a modulated frequency-falling range of the beat signal, each of the first frequency component and the second frequency component of the beat signal having a local peak strength of the beat signal; and obtain positional information of the target based on the at least one pair of the first and second frequency components of the beat signal. The signal processor is configured to change a value of the time interval for the current sequence of the successive selections of the outputs of the plurality of receiving channels so that the value of the time interval for a current sequence of the successive selections of the outputs of the plurality of receiving channels is different from a value of the time interval for a previous sequence of the successive selections of the outputs of the plurality of receiving channels.

The radar apparatus according to the one aspect of the present disclosure achieves a technical effect of correctly detecting a target even if the target is located at a distance, which corresponds to a frequency equal to or higher than Nyquist frequency as the half of the frequency of sampling of beat signals, from the radar apparatus. The reasons will be described hereinafter.

Usually, as illustrated in FIG. 9, when a beat signal is sampled at a sampling frequency fs, frequency components Q of the beat signal corresponding to a target, which are higher than Nyquist frequency as the half of the sampling frequency fs are shifted (folded) to frequency components lower than the Nyquist frequency and symmetrical to the frequency components Q as aliases (see dashed lines Q′ in FIG. 9 and the hatched arrow).

Thus, the frequency components of the beat signal corresponding to the target, which are higher than the Nyquist frequency, appear as falsely frequency components (aliases) of a false target closer than the actual target.

At that time, for the beat signal whose frequency is lower than the Nyquist frequency fn, frequency components P of the beat signal corresponding to the actual target are obtained based on a result of the sampling, and therefore no aliases appear in the frequency spectrum (see FIG. 9).

Thus, the first phase difference (X degrees) between a pair of upbeat signals Bu of a pair of receiving channels (channel ch1 and ch2) and the second phase difference (−X degrees) between a pair of downbeat signals Bd of the pair of receiving channels (channel ch1 and ch2) are identical to each other with their signs being opposite to each other (see FIG. 10). Thus, as described later, it is possible to perform a phase pair-matching method based on the upbeat signals Bu and the downbeat signals Bd of the pair of receiving channels ch1 and ch2. This enables the azimuth of a target to be accurately obtained.

In contrast, as described above, if the beat signal whose frequency is higher than the Nyquist frequency fn, frequency components Q of the beat signal corresponding to the target appear as falsely frequency components (aliases) Q′ of a false target in the frequency spectrum (see FIG. 9).

That is, for the beat signal whose frequency is higher than the Nyquist frequency fn (see dashed lines in FIG. 11), frequency components (aliases) of a beat signal (see solid lines in FIG. 11) corresponding to a false target (see Q′ in FIG. 9) closer than the actual target are obtained based on a result of the sampling.

Thus, as illustrated in FIG. 11, the first phase difference +(X+β) degrees between a pair of upbeat signals Bu of a pair of receiving channels (channel ch1 and ch2) and the second phase difference −(X−β) degrees between a pair of downbeat signals Bd of the pair of receiving channels (channel ch1 and ch2) are not identical to each other with their signs being opposite to each other (see FIG. 11). Thus, as described later, it is difficult to perform the phase pair-matching method based on the upbeat signals Bu and the downbeat signals Bd of the pair of receiving channels ch1 and ch2 with high accuracy. This makes it difficult to obtain the azimuth of a target with high accuracy. Note that reference character β represents a corrected value of a phase difference between the channels ch1 and ch2.

In order to address such a problem, the signal processor of the radar apparatus according to the one aspect of the present disclosure is configured to change a value of the time interval for the current sequence of the successive selections of the outputs of the plurality of receiving channels so that the value of the time interval for the current sequence of the successive selections of the outputs of the plurality of receiving channels is different from a value of the time interval for a previous sequence of the successive selections of the outputs of the plurality of receiving channels (see FIG. 3 described later). For example, as illustrated in FIG. 3, the signal processor is configured to set the time interval (tc) to a value tc1 for the first sequence of the successive selections of all the receiving channels, and set the time interval (tc) to a value unequal to the value tc1 for the second sequence of the successive selections of all the receiving channels.

This configuration allows a value of the sampling cycle of an upbeat signal and a downbeat signal and a value of the time interval for each sequence of the successive selections of all the receiving channels to be not correlated to values of the sampling cycle of the upbeat signal and the downbeat signal and values of the time interval for the other sequences of the successive selections of all the receiving channels. This reduces shifting (folding) of frequency components of the beat signal corresponding to a target, which are higher than Nyquist frequency, to frequency components (aliases) lower than the Nyquist frequency.

Specifically, as described above, even if the receiving channels are compensated for their differences in phase, repeats of a constant phase difference between each pair of adjacent receiving channels may cause aliases.

Thus, the radar apparatus according to the one aspect of the present disclosure changes a value of the time interval for the current sequence of the successive selections of the outputs of the plurality of receiving channels so that the value of the time interval for the current sequence of the successive selections of the outputs of the plurality of receiving channels is different from a value of the time interval for a previous sequence of the successive selections of the outputs of the plurality of receiving channels. This makes possible that a phase difference (a corrected value thereof) between each pair of adjacent receiving channels for a current sequence of the successive selections of the outputs of the plurality of receiving channels is different from a phase difference (a corrected value thereof) between a corresponding pair of adjacent receiving channels for a previous sequence of the successive selections of the outputs of the plurality of receiving channels. This reduces aliases due to repeats of a phase difference between each pair of adjacent receiving channels.

This enables the pair-matching method using sampled values of the upbeat signal Bu and sampled values of the downbeat signal Bd of the beat signal B to be performed with high accuracy.

In other words, the radar apparatus according to the one aspect of the present disclosure reduces shifting (folding) of frequency components of a beat signal corresponding to a target, which are higher than Nyquist frequency to frequency components lower than the Nyquist frequency, thus correctly detecting at least one target without detecting, as the target (true target), a false target located closer to the radar apparatus than the true target.

Thus, the radar apparatus according to the one aspect of the present disclosure accurately detects the azimuth of at least one target without adverse affect from aliases. This eliminates anti-aliasing filters that are usually used for such radar apparatuses, making it possible to reduce in size the radar apparatus.

In a first explanatory embodiment of the one aspect of the present disclosure, the plurality of the receiving channels includes a plurality of receiving antennas each configured to receive the return of the radar wave from the target as the received signal, a receiving unit, and a switch configured to successively select the receiving signals from the plurality of receiving antennas to be supplied to the receiving unit. The receiving unit is configured to mix the successively selected received signals with the local signal to output the beat signal based on successive outputs of the receiving unit. The signal processor is configured to successively select the outputs of the plurality of receiving channels based on the successive selections of the receiving signals from the plurality of receiving antennas by the switch.

With the radar apparatus according to the first explanatory embodiment, the receiving channels (antennas) time-divisionally share the receiving unit. This configuration achieves a technical effect of eliminating the need to provide a plurality of expensive receiving units, resulting in reduction of the radar apparatus in size and cost.

In a second explanatory embodiment of the one aspect of the present disclosure, the plurality of receiving channels have a predetermined arrangement, and the signal processor is configured to successively select the outputs of the plurality of receiving channels in order of the predetermined arrangement of the plurality of receiving channels.

This configuration simplifies the structure of the receiver.

Note that the sentence “the signal processor is configured to successively select the outputs of the plurality of receiving channels in order of the predetermined arrangement of the plurality of receiving channels” means that the signal processor is configured to sequentially select the outputs of the plurality of receiving channels one by one in a direction of the predetermined arrangement of the plurality of receiving channels.

For example, if the plurality of receiving antennas are arranged in line, the signal processor successively select the plurality of receiving channels one by one from one end channel to the other end channel. If the plurality of receiving antennas are arranged in matrix, the signal processor successively select the plurality of receiving channels one by one from the first row (first column) to the final row (final column).

In a third explanatory embodiment of the one aspect of the present disclosure, the plurality of receiving antennas are arranged in line.

With the configuration, comparison between strength components and phases of beat signal components of the beat signal from the respective receiving channels with one another allows the azimuth of at least one target within a plane including a normal direction (front direction) of a radar-wave transmitting surface of the receiving antennas and the linear arrangement direction of the receiving antennas, that is, a horizontal angle with respect to the normal direction when the angle of the normal direction is set to 0 degrees. Thus, if the radar apparatus is installed in a motor vehicle such that the linear arrangement direction of the receiving antennas is parallel to the width direction of the motor vehicle, the radar apparatus can be suitably used as a forward-looking radar apparatus.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating a radar apparatus according to the first embodiment of the present disclosure;

FIG. 2 is a view schematically illustrating how to set a beam width between a transmitting antenna and receiving antennas illustrated in FIG. 1;

FIG. 3 is a view schematically illustrating that the time interval (selecting period) tc each successive selection of a mixer (a receiving channel) illustrated in FIG. 1 is changed for each sampling cycle Ts;

FIG. 4A is a view schematically illustrating an example of the waveform of a beat signal inputted to a signal processor illustrated in FIG. 1;

FIG. 4B is a view schematically illustrating an example of the waveform of a beat signal component of the beat signal illustrated in FIG. 4A;

FIG. 5 is a flowchart schematically illustrating a target information detecting routine to be executed by the signal processor illustrated in FIG. 1;

FIG. 6 is a block diagram schematically illustrating a radar apparatus according to the second embodiment of the present disclosure;

FIG. 7 is a view schematically illustrating switching times of a receiver switch illustrated in FIG. 6;

FIG. 8 is a block diagram schematically illustrating a radar apparatus according to the third embodiment of the present disclosure;

FIG. 9 is a view schematically illustrating a frequency spectrum in which frequency components Q of a beat signal corresponding to a target, which are higher than Nyquist frequency fn, are shifted (folded) to frequency components Q′ lower than the Nyquist frequency fn and symmetrical to the frequency components Q;

FIG. 10 is a view schematically illustrating sampled values of upbeat and downbeat signals of beat signal components, which are lower in frequency than Nyquist frequency;

FIG. 11 is a view schematically illustrating sampled values of upbeat and downbeat signals of beat signal components, which are higher in frequency than Nyquist frequency; and

FIG. 12 is a view schematically illustrating the principle of measuring the angular direction of a target using the phases of signals produced by an array of antennas.

### DETAILED DESCRIPTION OF EMBODIMENT

Embodiments of the present disclosure will be described hereinafter with reference to the accompanying drawings. In the embodiments, like parts between the embodiments, to which like reference characters are assigned, are omitted or simplified in redundant description.

### First Embodiment

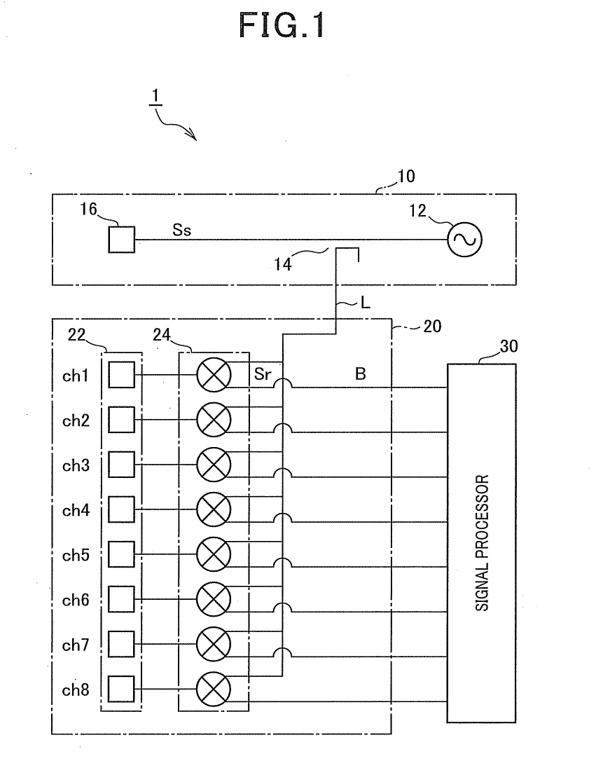

An example of the overall structure of a radar apparatus 1 according to the first embodiment is illustrated in FIG. 1. Referring to FIG. 1, the radar apparatus 1 includes a transmitter 10, a receiver 20, and a signal processor 30.

The transmitter 10 is adapted to generate a transmit signal with a frequency cyclically varying in time, and transmit the transmit signal as a radar wave. For example, the transmitter 10 is comprised of an oscillator 12, a distributor 14, and a transmitting antenna 16. The oscillator 12 is adapted to generate a high frequency signal in a millimeter wave band; the high frequency signal is so modulated that the frequency thereof is increased and decreased cyclically. The distributor 12 is adapted to split in power the high frequency signal into a transmit signal Ss and a local signal L. The transmitting antenna 16 is adapted to radiate the transmit signal Ss as a radar wave.

The frequency of the transmit signal Ss varies in the form of a triangular wave. In this embodiment, the central frequency Fo of the transmit signal Ss is set to 76.5 GHz, the frequency variation ΔF of the transmit signal Ss is set to 100 MHz, and the variation cycle Td is set to 1.024 ms. The beam width of a radar wave to be transmitted from the transmitting antenna 16 is set to cover the whole of a zone detectable by the radar apparatus 1.

The receiver 20 is adapted to receive returns of the radar wave transmitted from the transmitter 10 and reflected from at least one target, and generate beat signals based on the returns of the transmitted radar wave and the local signal with the same frequency as that of the transmitted radar wave. For example, the receiver 20 is comprised of a number of receiving antennas 22 and a corresponding number of receiving units 24. As the number of receiving antennas 22, eight receiving antennas 22 are provided in this embodiment, and, therefore, as the number of receiving units 24, eight receiving units 24 are provided.

The eight receiving antennas 22 are, for example, arrayed in line and adapted to receive returns of the radar wave transmitted from the transmitter 10. For example, each of the receiving antennas 22 is constructed by a horn antenna. Each of the receiving antenna 22 is also adapted to generate a received signal Sr based on a corresponding return of the radar wave.

Each of the eight receiving units 24 is comprised of a high-frequency mixer connected to a corresponding one of the receiving antennas 22. Each of the receiving units 24 is adapted to mix a corresponding received signal Sr with the local signal L supplied from the distributor 14 to generate a beat signal component comprised of a frequency component equivalent to a difference in frequency between the received signal Sr and the local signal L.

That is, the receiver 20 has eight receiving channels ch1 to ch8 each including a corresponding one of the receiving antennas 22 and a corresponding one of the receiving units 24, and the receiving units ch1 to ch8 generate a beat signal B composed of the beat signal components.

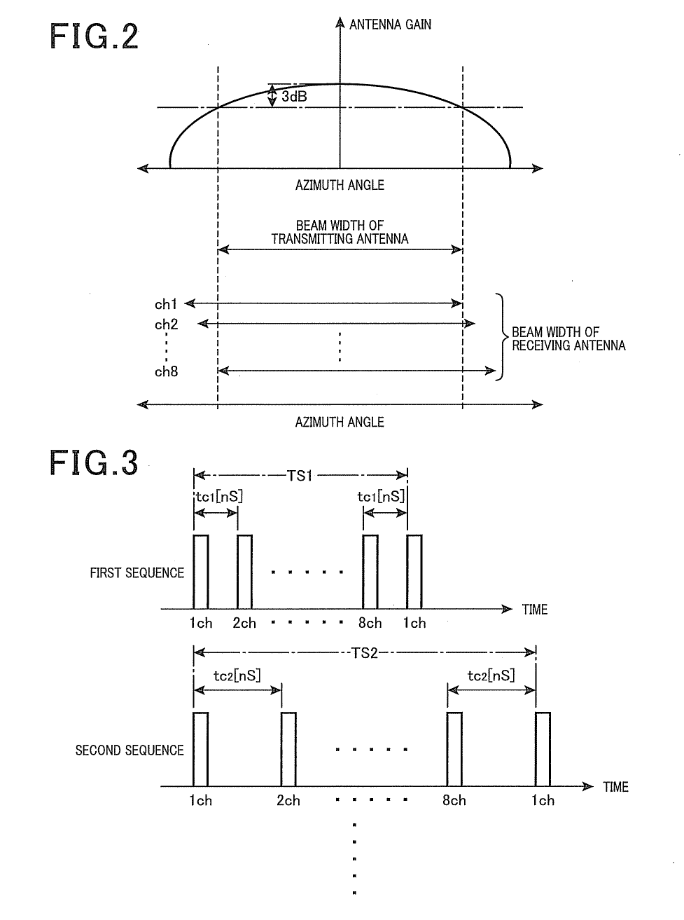

Referring to FIG. 2, if an angular range, in which a decrease in gain of a beam formed by an antenna from the central direction of the front surface of the antenna is within 3 dB is defined as a beam width, the receiving antenna 22 of each receiving channel is for example designed such that the beam width thereof covers the whole of a beam width of the transmitting antenna 16; the beam width of the transmitting antenna 16 is set to 20 degrees. Specifically, each of the receiving antennas has the directivity that causes a return of the radar wave transmitted from any angular direction over a beam range of the radar wave to be received. This allows a digital beam forming (DBF) technique to be used in phase comparison, as will be described later, when information about azimuth of a target is obtained.

The center-to-center interval dw between adjacent two of the receiving antennas 22 is determined so as to meet the aforementioned equation [3] in order to measure the azimuth of any targets present over a range of a beam transmitted from the transmitter 10 correctly:

$$dw \leq \frac{λ}{2 sin ( φ / 2 )} \qquad [ 3 ]$$

where represents the beam width of a radar wave transmitted from the transmitter 10, and λ represents the mean wavelength of the transmit signal Ss. How to establish the equation [3] will be described later.

In this embodiment, the mean wavelength λ of the transmit signal Ss is set to 1/Fo=3.92 mm. Thus, the center-to-center interval dw is set to 8 mm smaller than 11.3 mm, which satisfies the equation [3].

The signal processor 30 has functions of: sampling values of a beat signal B of the respective receiving channels every sampling cycle Ts, and performing the pair-matching method using the sampled values of the beat signal B of the respective receiving channels, thus obtaining at least positional information of a target.

Specifically, the signal processor 30 successively selects outputs of the respective receiving units 24 to sample values of the beat signal B. The signal processor 30 cyclically repeats a cycle (sequence) of the successive selections of all the receiving units 24 (receiving channels); a cycle Ts of the successive selections of all the receiving units 24 is for example shorter than the variation cycle Td in the frequency of the transmit signal Ss. The cycle Ts of the successive selections of all the receiving units 24 will also be referred to as a “sampling cycle (selecting cycle) Ts” hereinafter.

In this embodiment, the time interval (selecting period) tc between each successive selection of receiving units (receiving channels) is changed for each sampling cycle Ts. In other words, the sampling cycle Ts is changed for each sequence of the successive selections of all the receiving units 24. Preferably, the time interval tc between each successive selection of receiving units (receiving channels) is set to be lower than the half of the sampling cycle Ts in light of the sampling theorem.

For example, as illustrated in FIG. 3, the signal processor 30 sets the time interval tc to a value tc1 [ns] for the first sequence of the successive selections of all the receiving units 24, and the signal processor 30 sets the time interval tc to a value tc2 [ns] unequal to the value tc1 for the second sequence of the successive selections of all the receiving units 24. In this embodiment, a value of the time interval tc can be set to be equal to or lower than, for example, 0.25 μs.

That is, in this embodiment, the signal processor 30 changes at least a value of the time interval tc for an n-th sequence (current sequence) of the successive selections of all the receiving units 24 so that the value of the time interval tc for the n-th sequence of the successive selections of all the receiving units 24 is different from a value of the time interval tc for a (n−1)-th sequence (previous sequence) of the successive selections of all the receiving units 24 (n is an integer being 2 or more). In other words, the signal processor 30 changes at least a value of the sampling cycle Ts for a n-th sequence of the successive selections of all the receiving units 24 so that the sampling cycle Ts for the n-th sequence of the successive selections of all the receiving units 24 is different from a value of the sampling cycle Ts for the (n−1)-th sequence of the successive selections of all the receiving units 24. For example, in FIG. 3, a value Ts2 of the sampling cycle Ts for the second sequence of the successive selections of all the receiving units 24 is set to be different from a value Ts1 of the sampling cycle Ts for the first sequence of the successive selections of all the receiving units 24.

To sum up, the signal processor 30 successively selects the receiving channels ch1 to ch8 of the receiver 20, thus successively selecting, at the time intervals tc, outputs of the respective receiving units 24.

More specifically, the signal processor 30 includes a typical microcomputer comprised of a CPU, a storage unit (a ROM and/or a RAM), and an I/O. The signal processor 30 also includes an A/D converter operative to convert the sampled values of the beat signal B into digital values of the beat signal B of the respective receiving channels of the receiver 20, so that the digital sampled values of the beat signal B of the respective receiving channels are stored in the storage unit. The signal processor 30 also includes an arithmetic processing unit operative to perform operations of Fast Fourier Transform (FFT) on the digital sampled values of the beat signal B of the respective receiving channels. Note that the sampling cycle Ts can be set to be equal to the selecting cycle Tx or different therefrom.

In the radar apparatus 1 according to the first embodiment constructed set forth above, a high frequency signal, which is so modulated that the frequency thereof is increased and decreased cyclically, is generated by the oscillator 12 and divided in power into a transmit signal Ss and a local signal L. The transmit signal Ss is radiated from the transmitting antenna 16 as a radar wave.

Returns of the radar wave transmitted from the transmitter 10 and reflected from objects including a target are received by all the receiving antennas 22, so that received signals Sr are respectively supplied to the receiving units 24. Each of the received signals Sr is mixed with the local signal L by a corresponding one of the receiving units 24. In this embodiment, the receiving units 24 are successively selected by the signal processor 30, so that outputs of the receiving units 24 are successively selected. A sequence (cycle) of the successive selections of all the receiving units 24 (all the receiving channels ch1) is cyclically repeated with its cycle (sampling cycle Ts) being shorter than the variation cycle Td in the frequency of the transmit signal Ss, so that values of the beat signal B of the respective receiving channels are sampled. The sampled values of the beat signal B of the respective receiving channels are supplied to the signal processor 30 to be converted into digital sampled values of the beat signal B.

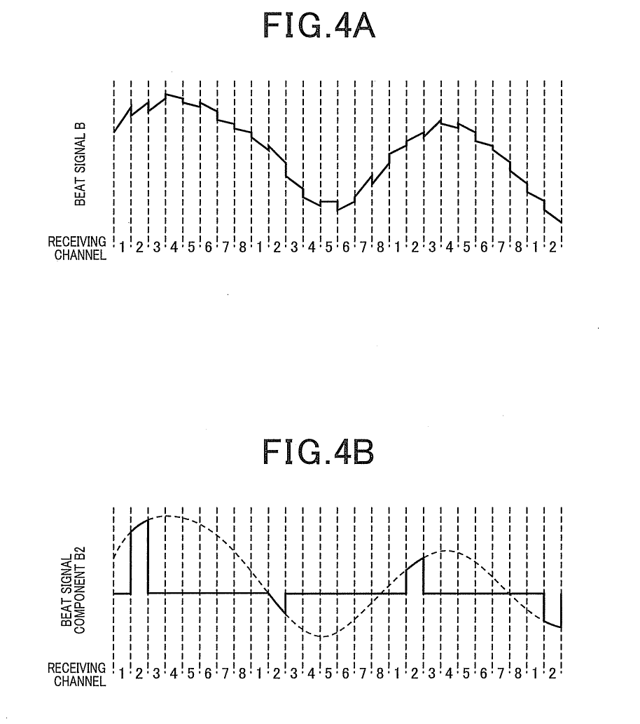

In this embodiment, because outputs of the receiving units 24 (receiving channels ch1) are successively selected every sampling cycle Ts, beat signal components B1 to B8 as outputs of the receiving units 24 (the respective receiving channels ch1 to ch8) are time-divisionally multiplexed every sampling cycle Ts, so that the beat signal B is generated every sampling cycle Ts; an example of the waveform of the beat signal B is illustrated in FIG. 4A. As an example of the beat signal components B1 to B8, the beat signal component B2 is illustrated in FIG. 4B.

In addition, in this embodiment, the sequence of the successive selections of all the receiving channels ch1 to ch8 (receiving units 24) is repeated every sampling cycle Ts within one variation cycle Td in the frequency of the transmit signal Ss, resulting in that the number of values of each of the beat signal components B1 to B8 are sampled; the number of sampled values of each of the beat signal components B1 to B8 is expressed by Td/Ts. The adjacent sampling timings of adjacent receiving channels for each sequence are shifted from each other by the time interval tc.

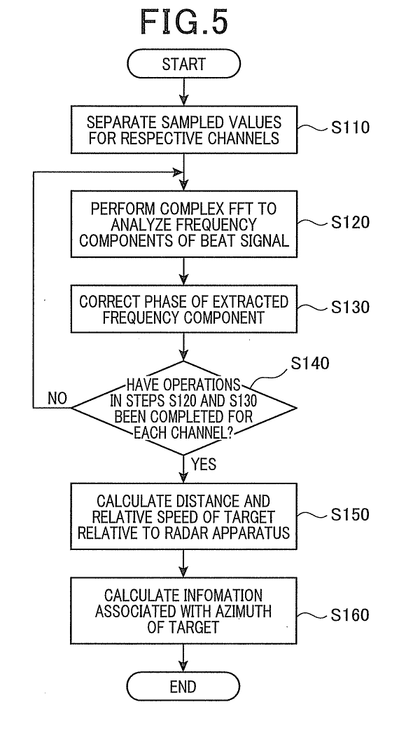

FIG. 5 illustrates a flowchart schematically illustrating a target information detecting routine to be executed by the signal processor 30. Specifically, the CPU of the signal processor 30 reads the target information detecting routine stored in the storage unit, and executes the target information detecting routine. In other words, the target information detecting routine is launched by the CPU of the signal processor 30 each time sampled digital values of the beat signal B of the respective receiving channels within one variation cycle Td in the frequency of the transmit signal Ss are stored in the storage unit.

When launching the target information detecting routine, the CPU of the signal processor 30 separates the sampled digital values of the beat signal B of the respective receiving channels ch1 to ch8 into sampled digital values of each of the beat signal components B1 to B8 (each of the receiving channels ch1 to ch8) in step S110.

Next, the CPU performs a complex FFT (Fast Fourier Transform), to which an algorithm for FFT is applied as an example of algorithms of the complex FFT, on the separated sampled digital values of one beat signal component Bi (i=1, 2, . . . , 7, or 8) in the beat signal component B1 to B8 i (i=1, 2, . . . , or 8) in the beat signal components B1 to B8 to thereby analyze frequency components of the beat signal component Bi.

For example, the CPU according to this embodiment performs the complex FFT on one half of the sampled digital values of the beat signal component Bi (i.e., sampled digital values in a modulated frequency-rising range), and on the other half of the sampled digital values of the beat signal component Bi (i.e., sampled digital values in a modulated frequency-falling range). As a result of the operations of the complex FFT, frequency components of the beat signal component Bi (an upbeat signal Bu and a downbeat signal Bd) are obtained in step S120; each of the frequency components has strength and a phase.

After the complex FFT operations in step S120, the CPU extracts at lest one of the frequency components, whose strength shows a local peak, of the beat signal component Bi in step S130; the at least one of the frequency components of the beat signal component Bi will be expressed by “an extracted frequency component fb”.

In step S130, the CPU corrects the phase θi of the extracted frequency component fb of the beat signal component Bi.

Specifically, the CPU calculates a corrected phase θhi(fb) of the phase θi of the extracted frequency component fb of the beat signal component Bi in accordance with the following equation [4]:

θhi(fb)=θi(fb)·H1·H2 [4]

where

H1=exp{−j·2π·fb·(i−1)·tc}

H2=exp{−j·δi}

where (i−1)·tc represents the elapsed time (ti−t1) between time t1 when the first receiving channel ch1 is selected and time ti when a receiving channel chi is selected at time ti, δi represents a phase lag of the received signal Sr previously measured between the receiving antenna 22 and the receiving unit 24 of a corresponding receiving channel chi, and j represents an imaginary unit.

Specifically, if a phase shift σ occurs between the beat signal components of adjacent two receiving channels, the phase shift σ can be expressed by the following equation [5]:

σ=2π·fi·(i−1)tc [5]

Therefore, multiplying, by “exp{−j·σ}”, that is, the H1, the phase θi of the at least one of the frequency components of the beat signal component Bi allows a phase shift of the beat signal component Bi caused by selection of at least one receiving channel to be compensated.

In addition, an additional phase shift (i.e., the phase lag δi) occurs between the beat signal component Bi and an alternative beat signal component based on the difference between a path from the receiving antenna 22 to the receiving unit 24 of the receiving channel chi corresponding to the beat signal component Bi and a path from the receiving antenna 22 to the receiving unit 24 of a corresponding receiving channel corresponding to the alternative beat signal component. Thus, multiplying, by “exp {−j·δi}”, that is, the H2, the product of the phase θi and the value H1 allows the phase lag δi to be compensated.

After the phase compensation operations in step S130, the CPU determines whether the complex FFT operations in step S120 and the phase compensation operations in step S130 have been completed for each of the beat signal components B1 to B8 corresponding to the receiving channels ch1 to ch8 in step S140. If it is determined that the complex FFT operations in step S120 and the phase compensation operations in step S130 have not been completed for each of the beat signal components B1 to B8 (NO in step S140), the CPU returns to step S120, and repeatedly performs the complex FFT operations in step S120 and the phase compensation operations in step S130 for another beat signal component in the beat signal component B1 to B8 until the complex FFT operations in step S120 and the phase compensation operations in step S130 have been completed for each of the beat signal components B1 to B8 (YES in step S140).

As a result, if it is determined that the complex FFT operations in step S120 and the phase compensation operations in step S130 have been completed for each of the beat signal components B1 to B8 (YES in step S140), the CPU proceeds to step S150.

As described above, the frequency components of each of the beat signal components B1 to B8 have been obtained in step S120; each of the frequency components has strength and a phase.

In step S150, it is assumed that the frequency components of each of the beat signal components B1 to B8 are first to n-th frequency components.

For example, in step S150, the CPU calculates a first average of the strength values of the first frequency components of the respective beat signal components B1 to B8, a second average of the strength values of the second frequency components of the respective beat signal components B1 to B8, . . . , and an n-th average of the strength values of the n-th frequency components of the respective beat signal components B1 to B8.

In step S150, the CPU extracts frequency components in the first to n-th frequency components within the modulated frequency-rising range, and extracts frequency components in the first to n-th frequency components within the modulated frequency-falling range; each of the corresponding averages of the extracted frequency components has a local peak. The extracted frequency components within the modulated frequency-rising range will be referred to as upbeat peaks, and the extracted frequency components within the modulated frequency-falling range will be referred to as downbeat peaks, hereinafter.

In step S150, the CPU extracts a pair of one of the upbeat peaks and one of the downbeat peaks; the strength value of the one of the upbeat peaks and that of the one of the downbeat peaks are substantially identical to each other.

In step S150, the CPU calculates, based on the extracted pair of the upbeat peak as a frequency fu and the downbeat peak as a frequency fd, the distance R and the relative speed V between the radar apparatus 1 and a target in accordance with the aforementioned equations [1] and [2].

Note that, in step S150, if the CPU extracts a plurality of pairs of ones of the upbeat peaks and corresponding ones of the downbeat peaks, the ones of the upbeat peaks being substantially identical in strength value to those of the downbeat peaks, the CPU calculates, based on each of the extracted pairs of the upbeat peaks as frequencies fu and the downbeat peaks as frequencies fd, the distance R and the relative speed V between the radar apparatus 1 and a corresponding target in accordance with the aforementioned equations [1] and [2]. This pairing technique is disclosed, for example, in U.S. Pat. No. 6,317,073 assigned to the same assignee as that of this application. Thus, the disclosures of the US patent are all incorporated herein by reference.

Next, in step S160, the CPU performs a phase pair-matching method based on the corrected phases θh1(fb), . . . , θh8(fb) of the upbeat and downbeat signals of the beat signal components B1, . . . , B8.

Specifically, the CPU compares the pairs of the corrected phases θh1(fb), . . . , θh8(fb) with one another. For example, in step S160, as a result of the comparison, the CPU extracts an upbeat pair of corrected phases of a pair of receiving channels in the modulated frequency-rising range, and a downbeat pair of corrected phases of the pair of receiving channels in the modulated frequency-falling range; an absolute value of the first phase difference between the pair of the corrected phases in the modulated frequency-rising range and that of the second phase difference between the pair of the corrected phases in the modulated frequency-falling range is identical to each other, and a sign of the first phase difference and that of the second phase difference are opposite to each other.

Then, in step S160, the CPU determines, based on the extracted upbeat pair of corrected phases of the pair of receiving channels and the extracted downbeat pair of corrected phases of the pair of receiving channels, the azimuth of at least one target in the following manner:

FIG. 12 shows the principle of determining the azimuth of a target using the phases of signals produced by an array of antennas. It is assumed that the center-to-center interval between adjacent two of the antennas is dw, and a return of a radar wave enters each of the antennas at an angle of α to a line extending perpendicular to the plane of the antennas. In general, returns of a radar wave from an object located at least several meters away from may be viewed as entering the antennas in parallel to each other. Thus, an optical path difference dl, equal to dw·sin α occurs between the radar returns entering adjacent two of the antennas in receiving channels ch1 and ch2, or ch2 and ch3. The optical path difference dl will cause signals produced in the receiving channels ch1 and ch2 or ch2 and ch3 to have a phase difference, which, in turn, appears as a phase difference between beat signals produced in the receiving channels ch1 and ch2 or ch2 and ch3. In an FM-CW radar, a phase difference ζ between beat signals caused by the optical path difference dl can be expressed as the following equation [6]:

$$ζ = \frac{2 π \cdot dl}{λ} \qquad [ 6 ]$$

Expressing the optical path difference dl by the center-to-center interval dw between the antennas and the incident angle α of the radar return in the above equation, the azimuth of the target (i.e., the incident angle α) is given by the following equation [7]:

$$α = {sin}^{- 1} ( \frac{ζ \cdot λ}{2 π \cdot dw} ) \qquad [ 7 ]$$

Thus, in step S160, the CPU calculates the azimuth of at least one target based on in accordance with the equations [6] and [7].

Note that the above equation [3] can be determined in the following manner. From the equation, the center-to-center interval dw is given by the following equation [8]:

$$dw = \frac{ζ \cdot λ}{2 π sin α} \qquad [ 8 ]$$

The phase difference ζ, which can be determined by the phase comparison is within a range of −π<ζ<π. The angular range α in which the radar wave having the beam width φ can detect an object is expressed by the following equation [9]:

−φ/2<α<φ/2

Thus, substituting ζ=π and α=φ/2 into the equation [8] allows the aforementioned equation [3] to be obtained:

In practice, it is advisable that the center-to-center interval dw be determined so that a target can be detected within a range wider than the beam width. Thus, the center-to-center interval dw satisfying the equation [3] enables desired information about the azimuth of a target to be obtained.

As described above, the radar apparatus 1 according to the first embodiment is configured to successively select any one of the receiving channels ch1 to ch8 at the variable time intervals tc equal to or lower than 0.25 μs. This configuration allows a series of eight beat signal components to be viewed as being substantially simultaneously inputted to the signal processor 30. This makes it possible to determine the azimuth of at least one target based on the phases of the beat signal components obtained by the respective receiving channels ch1 to ch8, resulting in improved accuracy in measuring the azimuth as compared with that obtained using only the strength values of beat signal components.

The radar apparatus 1 according to the first embodiment is also configured to compensate for shifts and/or delays in phase of the beat signal components obtained by the respective receiving channels ch1 to ch8; these shifts and/or delays are caused by sampling-time differences of values of the beat signal components and, differences in length of signal paths of the receiving channels ch1 to ch8 between the corresponding receiving antennas 22 and the corresponding receiving units 24. This allows determination of information associated with the azimuth of a target based on the corrected phases of the beat signal components with high accuracy.

In the first embodiment, the beam width of a radar wave transmitted from the transmitting antenna 16 is, as described above, set to 20 degrees, however, it is not limited to such an angle. For example, if the center-to-center interval dw of adjacent two of the receiving antennas 22 is set to 8 mm, it enables, as can be seen from the equation [7], the receiving antennas 22 to receive signals within a maximum angular range of 28.4 degrees (±14.2 degrees). Therefore, in the first embodiment, an increase in the beam width of radar waves to be emitted from the transmitting antenna 16 allows the radar detectable zone to be widened up to 28.4 degrees.

Further more, the radar apparatus 1 according to the first embodiment is configured to change a value of the time interval tc between each successive selection of receiving channels for each sampling cycle so as to reduce shifting (folding) of frequency components of a beat signal corresponding to a target, which are higher than Nyquist frequency from being shifted (folded), to frequency components lower than the Nyquist frequency (see FIG. 3). This configuration allows a value of the sampling cycle Ts of each cycle of the successive selections of all the receiving channels ch1 to ch8 to be changed from values of the sampling cycle Ts of the other cycles.

In other words, the radar apparatus 1 according to the first embodiment is designed such that a value of the sampling cycle Ts of a beat signal (an upbeat signal and a downbeat signal) B and a value of the time interval tc for each sequence of the successive selections of all the receiving channels ch1 to ch8 are different from values of the sampling cycle Ts of the beat signal B and values of the time interval tc for the other sequences of the successive selections of all the receiving channels ch1 to ch8.

This design allows a value of the sampling cycle Ts of an upbeat signal Bu and a downbeat signal Bd and a value of the time interval tc for each cycle of the successive selections of all the receiving channels ch1 to ch8 to be not correlated to values of the sampling cycle Ts of the upbeat signal Bu and the downbeat signal Bd and values of the time interval tc for the other sequences of the successive selections of all the receiving channels ch1 to ch8. This reduces shifting (folding) of frequency components of the beat signal corresponding to a target, which are higher than Nyquist frequency, to frequency components (aliases) lower than the Nyquist frequency (see FIG. 3).

This enables the pair-matching method using sampled values of the upbeat signal Bu and sampled values of the downbeat signal Bd of the beat signal B to be performed with high accuracy.

In other words, the radar apparatus 1 according to the first embodiment reduces shifting (folding) of frequency components of a beat signal corresponding to a target, which are higher than Nyquist frequency to frequency components lower than the Nyquist frequency, thus correctly detecting the target without detecting, as the target (true target), a false target located closer to the radar apparatus 1 than the true target.

The radar apparatus 1 according to the first embodiment accurately detect the azimuth of at least one target without adverse affect from aliases. This eliminates anti-aliasing filters that are usually used for such radar apparatuses, making it possible to reduce in size the radar apparatus 1a.

### Second Embodiment

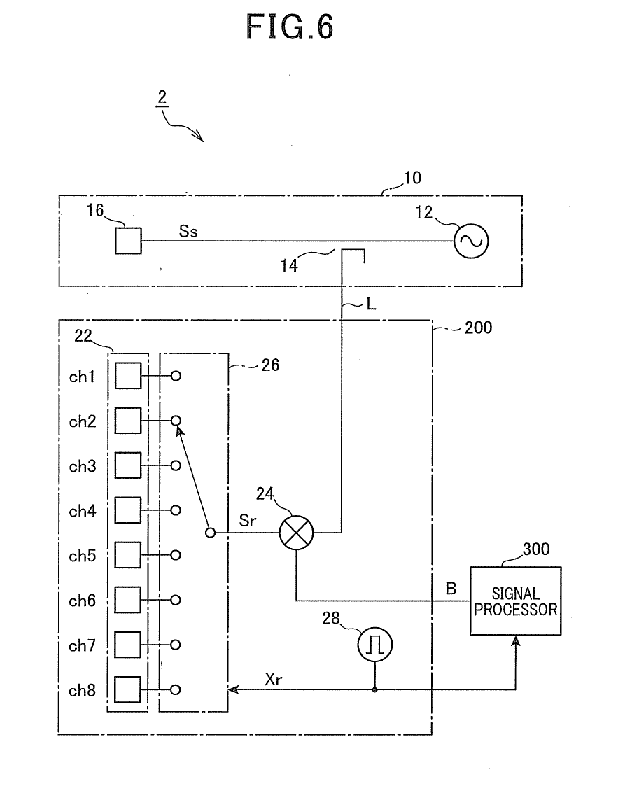

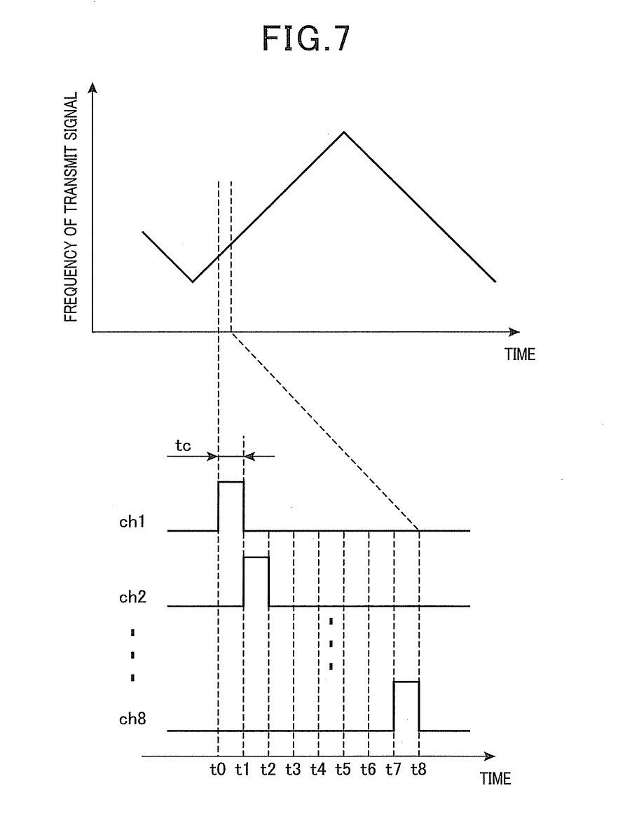

A radar apparatus 2 according to the second embodiment will be described with reference to FIGS. 6 and 7.

Referring to FIG. 6, the radar apparatus 2 includes a transmitter 10 identical to that according to the first embodiment, a receiver 200, and a signal processor 300.

The receiver 200 is adapted to receive returns of the radar wave transmitted from the transmitter 10 and reflected from at least one target, and generate beat signals based on the returns of the transmitted radar wave and the local signal with the same frequency as that of the transmitted radar wave. For example, the receiver 200 is comprised of a number of receiving antennas 22, a receiving unit 24a, a switch 26, and a selection signal generator 28.

The receiving antennas 22 are identical to those according to the first embodiment.

The receiving unit 24a is comprised of a high-frequency mixer selectively connectable to any one of outputs of the receiving antennas 22.

The switch 26 is responsive to a selection signal Xr inputted from the selection signal generator 28 to establish communication between any one of the receiving antennas 22 and the receiving unit 24, thus selecting any one of the received signals Sr. As the switch 26, a PIN diode switch, a MESFET (Metal-Semiconductor FET), a high-frequency switch, such as an RF-MEMS switch, or the like can be used.

The receiving unit 24a is adapted to mix a selected received signal Sr with the local signal L supplied from the distributor 14 to generate a beat signal B comprised of a frequency component equivalent to a difference in frequency between the received signal Sr and the local signal L.

As well as the first embodiment, the receiver 200 has eight receiving channels ch1 to ch8 each including a corresponding one of the receiving antennas 22 and the receiving units 24a via the switch 26, and the receiving units ch1 to ch8 generate a beat signal B.

The selection signal generator 28 serves as a device (a selection control means) for generating the selection signal Xr to control the switch 26. Specifically, as illustrated in FIG. 7, the selection signal generator 28 is adapted to generate the selection signal Xr that successively changes selection of the receiving antennas 22 (receiving channels ch1 to ch8) in order of the receiving channels ch1, ch2, ch3, . . . , and ch8. Note that the selection signal Xr is a train of pulses with time intervals tc, and also supplied to the signal processor 300. The switch 26 is adapted to shift a receiving channel to be selected each time a pulse of the selection signal Xr is inputted thereto.

That is, the selection signal Xr is a control signal to control the switch 26 to successively change selection of the receiving antennas 22 (receiving channels ch1 to ch8) in order of the receiving channels ch1, ch2, ch3, . . . , and ch8.

The selection signal generator 28 under control of, for example, the signal processor 300, cyclically generates the selection signal Xr, thus repeat a cycle of the successive selections of all the receiving channels ch1 to ch8; a period (sampling cycle) Ts of the successive selections of all the receiving channels ch1 to ch8 is shorter than the variation cycle Td in the frequency of the transmit signal Ss.

In the second embodiment, the time interval tc between each successive selection of receiving channels is changed for each sampling cycle Ts. In other words, the sampling cycle Ts is changed for each sequence (cycle) of the successive selections of all the receiving channels.

For example, as illustrated in FIG. 3, the selection signal generator 28 sets the time interval tc to a value tc1 [ns] for the first sequence of the successive selections of all the receiving channels, and the selection signal generator 28 sets the time interval tc to a value tc2 [ns] unequal to the value tc1. In this embodiment, a value of the time interval tc can be set to be equal to or lower than, for example, 0.25 μs.

That is, in this embodiment, the selection signal generator 28 changes at least a value of the time interval tc for an n-th sequence of the successive selections of all the receiving channels so that the value of the time interval tc for the n-th sequence of the successive selections of all the receiving channels is different from a value of the time interval tc for a (n−1)-th sequence of the successive selections of all the receiving channels (n is an integer being 2 or more). In other words, the selection signal generator 28 changes at least the sampling cycle Ts for a n-th sequence of the successive selections of all the receiving channels so that the sampling cycle Ts for the n-th sequence of the successive selections of all the receiving channels is different from the sampling cycle Ts for the (n−1)-th sequence of the successive selections of all the receiving channels.

That is, the receiver 200 includes eight receiving channels ch1 to ch8 corresponding to the respective receiving antennas 22, and all the receiving channels ch1 to ch8 time-share the single receiving unit 24a.

As well as the first embodiment, the beam width of a radar wave to be transmitted from the transmitting antenna 16 is set to cover the whole of a zone detectable by the radar apparatus 2, and the center-to-center interval dw is set to 8 mm.

The signal processor 300 has functions of: sampling values of a beat signal B of the respective receiving channels every sampling cycle Ts, and performs the pair-matching method using the sampled values of the beat signal B of the respective receiving channels, thus obtaining at least positional information of a target.

Specifically, the signal processor 300 includes a typical microcomputer comprised of a CPU, a storage unit (a ROM and/or a RAM), and an I/O. The signal processor 300 also includes an A/D converter that operates in synchronization with the input of a pulse of the selection signal Xr to convert the sampled values of the beat signal B of the respective receiving channels of the receiver 200 into digital values of the beat signal B of the respective receiving channels of the receiver 200, so that the digital sampled values of the beat signal B of the respective receiving channels are stored in the storage unit. The signal processor 300 also includes an arithmetic processing unit operative to perfoiin operations of Fast Fourier Transform (FFT) on the digital sampled values of the beat signal B of the respective receiving channels.

In the radar apparatus 2 according to the second embodiment constructed set forth above, a high frequency signal, which is so modulated that the frequency thereof is increased and decreased cyclically, is generated by the oscillator 12 and divided in power into a transmit signal Ss and a local signal L. The transmit signal Ss is radiated from the transmitting antenna 16 as a radar wave.

Returns of the radar wave transmitted from the transmitter 10 and reflected from objects including a target are received by all the receiving antennas 22, so that a received signal Sr corresponding to a receiving channel chi (i=any one of 1 to 8) selected by the receiving switch 26 is supplied to the receiving unit 24a.

That is, any one of the received signals Sr by the receiving channels ch1 to ch8 is successively selected. A cycle of the successive selections of the received signals Sr by the receiving channels ch1 to ch8 is periodically repeated with its cycle (sampling cycle Ts) being shorter than the variation cycle Td in the frequency of the transmit signal Ss, so that values of a beat signal B of the respective receiving channels are sampled. The sampled values of the beat signal B of the respective receiving channels are supplied to the signal processor 300 to be converted into digital sampled values of the beat signal B.

In this embodiment, because the received signals Sr of the receiving channels chi are successively selected every sequence, beat signal components B1 to B8 as outputs of the respective receiving channels ch1 to ch8 are time-division multiplexed every sequence, so that the beat signal B is generated every sequence; an example of the waveform of the beat signal B is illustrated in FIG. 4A. As an example of the beat signal components B1 to B8, the beat signal component B2 is illustrated in FIG. 4B.

In addition, in this embodiment, the sequence (cycle) of the successive selections of all the receiving channels ch1 to ch8 is repeated every sampling cycle Ts within one variation cycle Td in the frequency of the transmit signal Ss, resulting in that the number of values of each of the beat signal components B1 to B8 are sampled; the number of sampled values of each of the beat signal components B1 to B8 is expressed by Td/Ts. The adjacent sampling timings of adjacent receiving channels for each sequence are shifted from each other by the time interval tc.

A target information detecting routine to be executed by the signal processor 300 according to this embodiment is substantially identical to that according to the first embodiment except for the following points. For this reason, the following points will be mainly described hereinafter in accordance with FIG. 5.

When launching the target information detecting routine, the CPU of the signal processor 30 executes the operations in steps S110 to S130. In step S130, the CPU calculates a corrected phase θhi(fb) of the phase θ1 of the extracted frequency component fb of the beat signal component Bi in accordance with the aforementioned equation [4] based on: the elapsed time (ti−t1), that is, (i−1)·tc, between time t1 when the first receiving channel ch1 is selected and time ti when a receiving channel chi is selected at time ti, and δi representing a phase lag of the received signal Sr previously measured between the receiving antenna 22 of a corresponding receiving channel chi and the receiving unit 24a.

Thereafter, the CPU executes the operations in step S140 to 160, thus calculating the azimuth of a target.

As described above, the radar apparatus 2 according to the second embodiment is configured such that the receiving channels ch1 to ch8 time-divisionally share the receiving unit 24. This configuration achieves, in addition to the technical effects achieved by the radar apparatus 1 according to the first embodiment, a technical effect of eliminating the need to provide a plurality of expensive receiving units, resulting in reduction of the radar apparatus 2 in size and cost.

### Third Embodiment

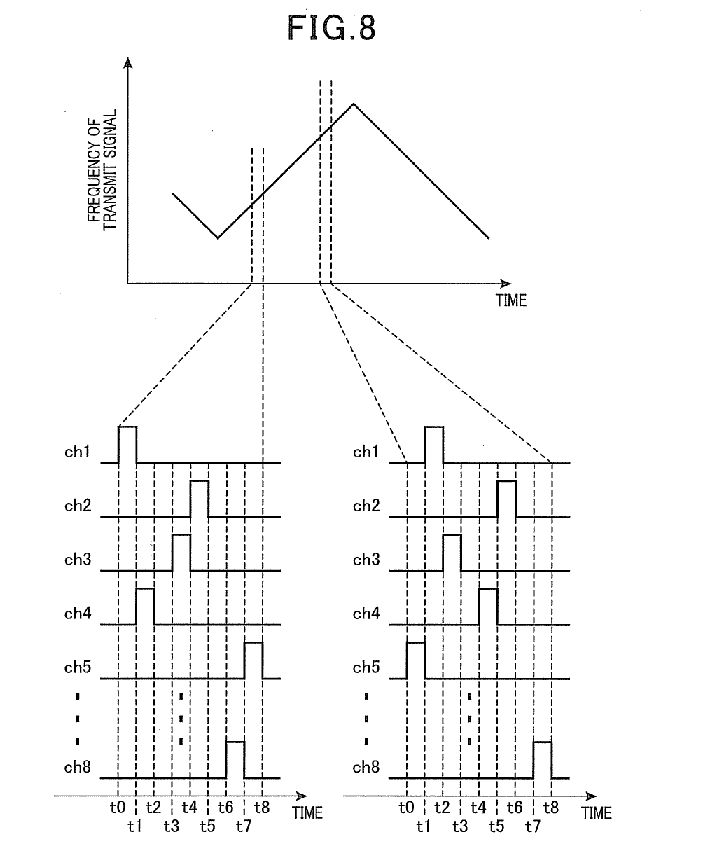

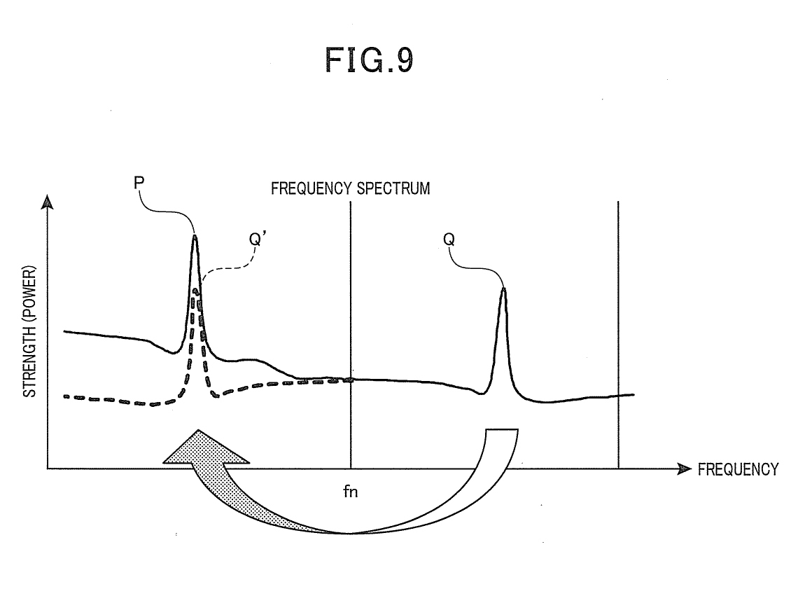

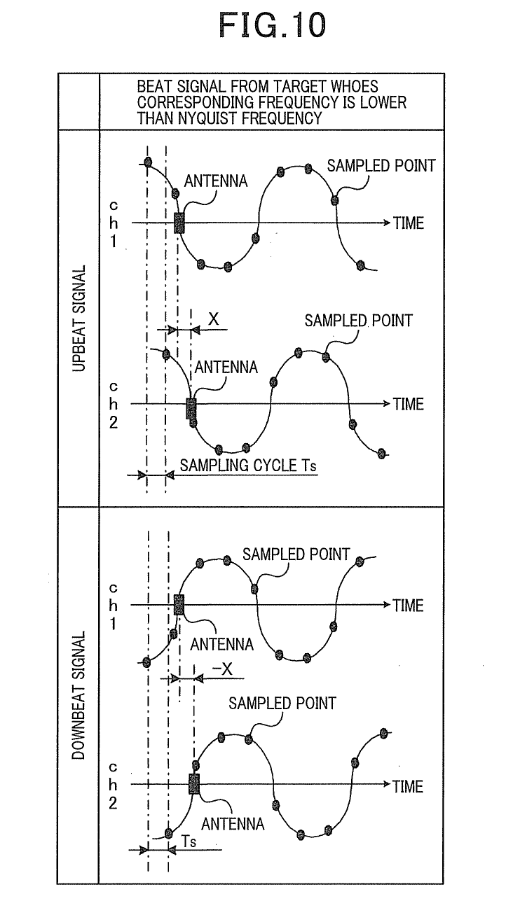

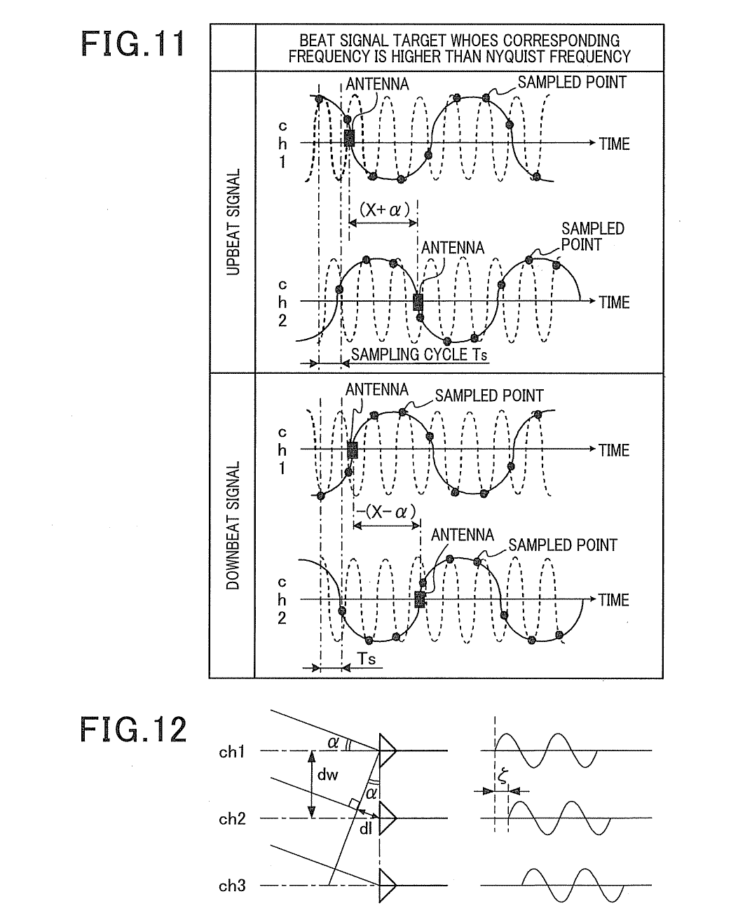

A radar apparatus according to the third embodiment will be described with reference to FIG. 8. Because the structure of the radar apparatus according to the third embodiment is identical to that of the radar apparatus 1 according to the first embodiment, the descriptions of the structure of the radar apparatus according to the third embodiment are omitted. A different point between the radar apparatus according to the third embodiment and the radar apparatus 1 is the order of the receiving channels ch1, ch2, ch3, . . . , and ch8 to be successively selected.

Specifically, the radar apparatus 1 successively selects the receiving channels ch1 to ch8 in the same order of the receiving channels ch1, ch2, ch3, . . . , and ch8 for each sampling cycle Ts.

However, the radar apparatus according to the third embodiment is configured to successively select the receiving channels ch1 to ch8 in random orders for respective sequences.

For example, as illustrated in FIG. 8, the radar apparatus according to the third embodiment is configured to successively select the receiving channels ch1 to ch8 in order of ch1→ch4→ch6→ch3→ch2→ch7→ch8 ch5 for one cycle (one value of the sampling cycle Ts), and successively select the receiving channels ch1 to ch8 in order of ch5→ch1→ch3→ch4→ch2→ch7→ch6→ch8 for another cycle (another value of the sampling cycle Ts).

This configuration prevents constant differences in phase of the received signals Sr caused by the order of successive selections of the receiving channels ch1 to ch8, thus reducing errors in the measured azimuth of a target; these errors is due to the order of successive selections of the receiving channels ch1 to ch8. This therefore eliminates compensation for the phase θi of the extracted frequency component fb of the beat signal component Bi based on the coefficient H1 in step S130.

The present disclosure is not limited to the aforementioned embodiments, and therefore can be modified or deformed.

For example, each of the first to third embodiments is provided with hone antennas as the receiving antennas 22, but another type of antennas, such as patch antennas, different from hone antennas in form and characteristic depending on a frequency band to be used by a corresponding radar apparatus and/or a space in which a corresponding radar apparatus is to be installed.

In each of the first to third embodiments, the beam width of the transmitting antenna 16 is set to 20 degrees, but the present disclosure is not limited thereto. When the center-to-center interval dw is set to 8 mm, the receiving antennas 20 can receive signals within the maximum angular range of 28.4 degrees (±14.2 degrees) as can be seen from the equation [7]. For this reason, an increase in the beam width of radar waves to be emitted from the transmitting antenna 16 allows the radar detectable zone to be easily widened up to 28.4 degrees.

While illustrative embodiments of the present disclosure has been described herein, the present disclosure is not limited to the embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. A radar apparatus comprising:
a transmitter configured to generate a transmit signal so modulated in frequency to cyclically change with time, and transmit the transmit signal as a radar wave;
a receiver comprising a plurality of receiving channels, each of the plurality of receiving channels being configured to receive a return of the radar wave from a target as a received signal,
the receiver being configured to output a beat signal based on the received signals of the plurality of receiving channels and a local signal having a frequency identical to the frequency of the transmit signal, the beat signal being composed of outputs of the plurality of receiving channels; and
a signal processor configured to:
successively select the outputs of the plurality of receiving channels at time intervals and repeat, at a sampling cycle, a sequence of the successive selections of the outputs of the plurality of receiving channels, thus sampling values of the beat signal;
extract at least one pair of a first frequency component of one of the sampled values of the beat signal in a modulated frequency-rising range of the beat signal and a second frequency component of one of the sampled values of the beat signal in a modulated frequency-falling range of the beat signal, each of the first frequency component and the second frequency component of the beat signal having a local peak strength of the beat signal; and
obtain positional information of the target based on the at least one pair of the first and second frequency components of the beat signal,
wherein the signal processor is configured to change a value of the time interval for a current sequence of the successive selections of the outputs of the plurality of receiving channels so that the value of the time interval for the current sequence of the successive selections of the outputs of the plurality of receiving channels is different from a value of the time interval for a previous sequence of the successive selections of the outputs of the plurality of receiving channels.

2. The radar apparatus according to claim 1, wherein the plurality of the receiving channels comprises:
a plurality of receiving antennas each configured to receive the return of the radar wave from the target as the received signal; and
a plurality of receiving units respectively connected to the plurality of the receiving channels, each of the plurality of receiving units being configured to mix a corresponding one of the received signals with the local signal, the receiver being configured to output the beat signal based on outputs of the plurality of receiving units as the outputs of the plurality of receiving channels,
wherein the signal processor is configured to successively select the outputs of the plurality of receiving units at the time intervals and repeat, at the sampling cycle, the sequence of the successive selections of the outputs of the plurality of receiving units, thus sampling the values of the beat signal.

3. The radar apparatus according to claim 1, wherein the plurality of the receiving channels comprises:
a plurality of receiving antennas each configured to receive the return of the radar wave from the target as the received signal;
a receiving unit; and
a switch configured to successively select the receiving signals from the plurality of receiving antennas to be supplied to the receiving unit, the receiving unit being configured to mix the successively selected received signals with the local signal to output the beat signal based on successive outputs of the receiving unit,
wherein the signal processor is configured to successively select the outputs of the plurality of receiving channels based on the successive selections of the receiving signals from the plurality of receiving antennas by the switch.

4. The radar apparatus according to clam 1, wherein the plurality of receiving channels have a predetermined arrangement, and the signal processor is configured to successively select the outputs of the plurality of receiving channels in order of the predetermined arrangement of the plurality of receiving channels.

5. The radar apparatus according to claim 2, wherein the plurality of receiving antennas are arranged in line.

6. The radar apparatus according to claim 1, wherein the signal processor is configured to correct a phase of the first frequency component of the beat signal in the modulated frequency-rising range of the beat signal and a phase of the second frequency component of the beat signal in the modulated frequency-falling range of the beat signal.

7. The radar apparatus according to claim 1, wherein the signal processor is configured to successively select the outputs of the plurality of receiving channels in random orders for respective sequences of the successive selections of the outputs of the plurality of receiving channels.
